(19) United States
(12) Patent Application Publication
(10) Pub. No.: US 2007/0133007 A1
(43) Pub. Date: Jun. 14, 2007

(54) Lithographic apparatus and device manufacturing method using laser trimming of a multiple mirror contrast device

(75) Inventor: Robert-Han Munnig Schmidt, Hapert (NL)

Correspondence Address: STERNE, KESSLER, GOLDSTEIN & FOX P.L.L.C., 1100 NEW YORK AVENUE, N.W., WASHINGTON, DC, 20005, US

(73) Assignee: ASML Netherlands B.V., Veldhoven (NL)

(21) Appl. No.: 11/302,489

(22) Filed: Dec. 14, 2005

(51) Int. Cl. G01B 11/02

(52) U.S. Cl. 356/511

(57) ABSTRACT

A lithographic apparatus comprises a topography measurement device, a patterning device, and a corrective device. The topography measurement device measures a topography of at least one mechanical element of a patterning device. The patterning device comprises an array of individually controllable mechanical elements that are arranged to impart a pattern to a radiation beam. The corrective device corrects a mechanical property of the at least one mechanical element on the basis of information obtained by the topography measurement device.

### BACKGROUND

1. Field of the Invention

The present invention relates to an optical apparatus, suitable for use as part of a lithographic apparatus.

2. Related Art

A lithographic apparatus is a machine that applies a desired pattern onto a substrate or part of a substrate. A lithographic apparatus can be used, for example, in the manufacture of flat panel displays, integrated circuits (ICs) and other devices involving fine structures. In a conventional apparatus, a patterning device, which can be referred to as a mask or a reticle, can be used to generate a circuit pattern corresponding to an individual layer of a flat panel display (or other device). This pattern can be transferred onto all or part of the substrate (e.g., a glass plate), by imaging onto a layer of radiation-sensitive material (resist) provided on the substrate.

Instead of a circuit pattern, the patterning means can be used to generate other patterns, for example a color filter pattern or a matrix of dots. Instead of a mask, the patterning device can comprise a patterning array that comprises an array of individually controllable elements. The pattern can be changed more quickly and for less cost in such a system compared to a mask-based system.

A flat panel display substrate is typically rectangular in shape. Lithographic apparatus designed to expose a substrate of this type can provide an exposure region that covers a full width of the rectangular substrate, or covers a portion of the width (for example half of the width). The substrate can be scanned underneath the exposure region, while the mask or reticle is synchronously scanned through a beam. In this way, the pattern is transferred to the substrate. If the exposure region covers the full width of the substrate then exposure can be completed with a single scan. If the exposure region covers, for example, half of the width of the substrate, then the substrate can be moved transversely after the first scan, and a further scan is typically performed to expose the remainder of the substrate.

Individual elements within the array of individually controllable elements can have slightly different physical properties, and therefore exhibit different responses to stimuli (e.g., an applied operating voltage). While the differences between elements of an array can be small, the differences are nevertheless important and readily noticeable in applications in which the use of such arrays requires high precision. An application where high precision is required is optical lithography, where non-uniformities in the shape of the individual elements of an array can result in a defective pattern being applied to a substrate (e.g., a pattern where a part thereof has been underexposed or overexposed).

What is needed is an apparatus and method for improving the consistency between elements of an array of individually controllable elements.

### SUMMARY

In one embodiment of the present invention, there is provided a lithographic apparatus comprising a topography measurement device, a patterning device, and a corrective device. The topography measurement device measures the topography of at least one mechanical element of a patterning device, the patterning device comprising an array of individually controllable mechanical elements which are arranged to impart a pattern to a radiation beam; and a corrective device arranged to correct a mechanical property of the at least one mechanical element on the basis of information obtained by the topography measurement device.

According to another embodiment of the present invention, there is provided a corrective system arranged to apply a corrective measure to at least one mechanical element of a patterning device. The patterning device comprising an array of individually controllable mechanical elements that are arranged to impart a pattern to a radiation beam. The system further comprises a topography measurement device and a corrective device. The topography measurement device measures the topography of the at least one mechanical element of the array. The corrective device corrects a mechanical property of the at least one mechanical element on the basis of information obtained by the topography measurement device.

According to a further embodiment of the present invention, there is provided a method of correcting at least one mechanical element of a patterning device. The patterning device comprises an array of individually controllable mechanical elements arranged to impart a pattern to a cross-section of a radiation beam. The method comprises measuring the topography of the at least one mechanical element and correcting a mechanical property of the at least one mechanical element on the basis of information provided by the topography measurement.

Further embodiments, features, and advantages of the present inventions, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated herein and form a part of the specification, illustrate one or more embodiments of the present invention and, together with the description, further serve to explain the principles of the invention and to enable a person skilled in the pertinent art to make and use the invention.

FIGS. 1 and 2 depict lithographic apparatus, according to various embodiments of the present invention.

FIG. 3 depicts a mode of transferring a pattern to a substrate according to an embodiment of the invention as show in FIG. 2.

FIG. 4 depicts an arrangement of optical engines, according to one embodiment of the present invention.

FIG. 5a depicts an array of individually controllable elements, according to one embodiment of the present invention.

FIG. 5b depicts an element of the array shown in FIG. 5a.

FIG. 5c depicts a cross-sectional view of the array of FIG. 5a along the line X-X.

FIGS. 6a and 6b depict constituent parts of the correction system shown in FIG. 1, according to one embodiment of the present invention.

FIGS. 7a to 7c depict the operation of the correction system as shown in FIGS. 6a and 6b, according to one embodiment of the present invention.

FIGS. 8a to 8f depict various corrective measures which can be applied to the individual element of the array as shown in FIG. 5b, according to various embodiments of the present invention.

The present invention will now be described with reference to the accompanying drawings. In the drawings, like reference numbers can indicate identical or functionally similar elements. Additionally, the left-most digit(s) of a reference number can identify the drawing in which the reference number first appears.

### DETAILED DESCRIPTION

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

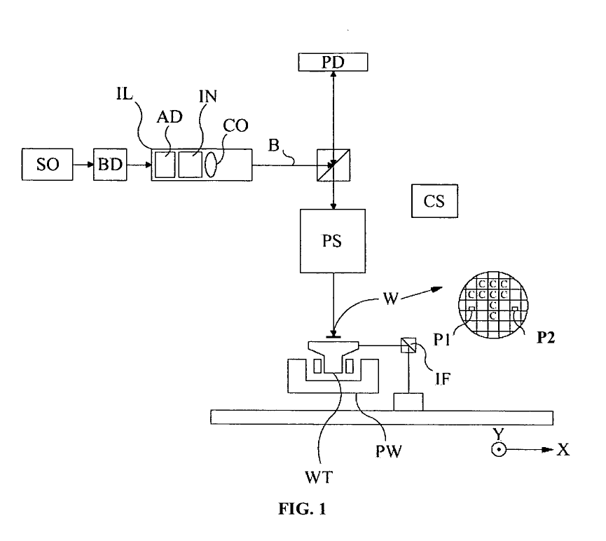

FIG. 1 schematically depicts the lithographic apparatus of one embodiment of the invention. The apparatus comprises an illumination system IL, a patterning device PD, a substrate table WT, a correction system CS arranged to apply a corrective measure to the patterning device PD (i.e., correct a mechanical property of the patterning device), and a projection system PS. The illumination system (illuminator) IL is configured to condition a radiation beam B (e.g., UV radiation).

The patterning device PD (e.g., a reticle or mask or an array of individually controllable elements) modulates the beam. In general, the position of the array of individually controllable elements will be fixed relative to the projection system PS. However, it can instead be connected to a positioner configured to accurately position the array of individually controllable elements in accordance with certain parameters.

The substrate table WT is constructed to support a substrate (e.g., a resist-coated substrate) W and connected to a positioner PW configured to accurately position the substrate in accordance with certain parameters.

The projection system (e.g., a refractive projection lens system) PS is configured to project the beam of radiation modulated by the array of individually controllable elements onto a target portion C (e.g., comprising one or more dies) of the substrate W.

The illumination system can include various types of optical components, such as refractive, reflective, magnetic, electromagnetic, electrostatic or other types of optical components, or any combination thereof, for directing, shaping, or controlling radiation.

The term “patterning device” or “contrast device” used herein should be broadly interpreted as referring to any device that can be used to modulate the cross-section of a radiation beam, such as to create a pattern in a target portion of the substrate. The devices can be either static patterning devices (e.g., masks or reticles) or dynamic (e.g., arrays of programmable elements) patterning devices. For brevity, most of the description will be in terms of a dynamic patterning device, however it is to be appreciated that a static pattern device can also be used without departing from the scope of the present invention.

It should be noted that the pattern imparted to the radiation beam may not exactly correspond to the desired pattern in the target portion of the substrate, for example if the pattern includes phase-shifting features or so called assist features. Similarly, the pattern eventually generated on the substrate may not correspond to the pattern formed at any one instant on the array of individually controllable elements. This can be the case in an arrangement in which the eventual pattern formed on each part of the substrate is built up over a given period of time or a given number of exposures during which the pattern on the array of individually controllable elements and/or the relative position of the substrate changes.

Generally, the pattern created on the target portion of the substrate will correspond to a particular functional layer in a device being created in the target portion, such as an integrated circuit or a flat panel display (e.g., a color filter layer in a flat panel display or a thin film transistor layer in a flat panel display). Examples of such patterning devices include, e.g., reticles, programmable mirror arrays, laser diode arrays, light emitting diode arrays, grating light valves, and LCD arrays.

Patterning devices whose pattern is programmable with the aid of electronic means (e.g., a computer), such as patterning devices comprising a plurality of programmable elements (e.g., all the devices mentioned in the previous sentence except for the reticle), are collectively referred to herein as “contrast devices.” In one example, the patterning device comprises at least 10 programmable elements, e.g., at least 100, at least 1000, at least 10000, at least 100000, at least 1000000, or at least 10000000 programmable elements.

A programmable mirror array can comprise a matrix-addressable surface having a viscoelastic control layer and a reflective surface. The basic principle behind such an apparatus is that, e.g., addressed areas of the reflective surface reflect incident light as diffracted light, whereas unaddressed areas reflect incident light as undiffracted light. Using an appropriate spatial filter, the undiffracted light can be filtered out of the reflected beam, leaving only the diffracted light to reach the substrate. In this manner, the beam becomes patterned according to the addressing pattern of the matrix-addressable surface.

It will be appreciated that, as an alternative, the filter can filter out the diffracted light, leaving the undiffracted light to reach the substrate.

An array of diffractive optical MEMS devices (micro-electro-mechanical system devices) can also be used in a corresponding manner. In one example, a diffractive optical MEMS device is comprised of a plurality of reflective ribbons that can be deformed relative to one another to form a grating that reflects incident light as diffracted light.

A further alternative example of a programmable mirror array employs a matrix arrangement of tiny mirrors, each of which can be individually tilted about an axis by applying a suitable localized electric field, or by employing piezoelectric actuation means. Once again, the mirrors are matrix-addressable, such that addressed mirrors reflect an incoming radiation beam in a different direction to unaddressed mirrors; in this manner, the reflected beam can be patterned according to the addressing pattern of the matrix-addressable mirrors. The required matrix addressing can be performed using suitable electronic means.

Another example PD is a programmable LCD array.

The lithographic apparatus can comprise one or more contrast devices. For example, it can have a plurality of arrays of individually controllable elements, each controlled independently of each other. In such an arrangement, some or all of the arrays of individually controllable elements can have at least one of a common illumination system (or part of an illumination system), a common support structure for the arrays of individually controllable elements, and/or a common projection system (or part of the projection system).

In an example, such as the embodiment depicted in FIG. 1, the substrate W has a substantially circular shape, optionally with a notch and/or a flattened edge along part of its perimeter. In an example, the substrate has a polygonal shape, e.g., a rectangular shape.

In example where the substrate has a substantially circular shape include examples where the substrate has a diameter of at least 25 mm, for instance at least 50 mm, at least 75 mm, at least 100 mm, at least 125 mm, at least 150 mm, at least 175 mm, at least 200 mm, at least 250 mm, or at least 300 mm. In an embodiment, the substrate has a diameter of at most 500 mm, at most 400 mm, at most 350 mm, at most 300 mm, at most 250 mm, at most 200 mm, at most 150 mm, at most 100 mm, or at most 75 mm.

In examples where the substrate is polygonal, e.g., rectangular, include examples where at least one side, e.g., at least 2 sides or at least 3 sides, of the substrate has a length of at least 5 cm, e.g., at least 25 cm, at least 50 cm, at least 100 cm, at least 150 cm, at least 200 cm, or at least 250 cm.

In one example, at least one side of the substrate has a length of at most 1000 cm, e.g., at most 750 cm, at most 500 cm, at most 350 cm, at most 250 cm, at most 150 cm, or at most 75 cm.

In one example, the substrate W is a wafer, for instance a semiconductor wafer. In one example, the wafer material is selected from the group consisting of Si, SiGe, SiGeC, SiC, Ge, GaAs, InP, and InAs. In one example, the wafer is a III/V compound semiconductor wafer. In one example, the wafer is a silicon wafer. In an embodiment, the substrate is a ceramic substrate. In one example, the substrate is a glass substrate. In one example, the substrate is a plastic substrate. In one example, the substrate is transparent (for the naked human eye). In one example, the substrate is colored. In one example, the substrate is absent a color.

The thickness of the substrate can vary and, to an extent, can depend, e.g., on the substrate material and/or the substrate dimensions. In one example, the thickness is at least 50 μm, e.g., at least 100 μm, at least 200 μm, at least 300 μm, at least 400 μm, at least 500 μm, or at least 600 μm. In one example, the thickness of the substrate is at most 5000 μm, e.g., at most 3500 μm, at most 2500 μm, at most 1750 μm, at most 1250 μm, at most 1000 μm, at most 800 μm, at most 600 μm, at most 500 μm, at most 400 μm, or at most 300 μm.

The substrate referred to herein can be processed, before or after exposure, in for example a track (a tool that typically applies a layer of resist to a substrate and develops the exposed resist), a metrology tool, and/or an inspection tool. In one example, a resist layer is provided on the substrate.

The term “projection system” used herein should be broadly interpreted as encompassing any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. Any use of the term “projection lens” herein can be considered as synonymous with the more general term “projection system.”

The projection system can image the pattern on the array of individually controllable elements, such that the pattern is coherently formed on the substrate. Alternatively, the projection system can image secondary sources for which the elements of the array of individually controllable elements act as shutters. In this respect, the projection system can comprise an array of focusing elements such as a micro lens array (known as an MLA) or a Fresnel lens array, e.g., to form the secondary sources and to image spots onto the substrate. In one example, the array of focusing elements (e.g., MLA) comprises at least 10 focus elements, e.g., at least 100 focus elements, at least 1000 focus elements, at least 10000 focus elements, at least 100000 focus elements, or at least 1000000 focus elements. In one example, the number of individually controllable elements in the patterning device is equal to or greater than the number of focusing elements in the array of focusing elements. In one example, one or more (e.g., 1000 or more, the majority, or about each) of the focusing elements in the array of focusing elements can be optically associated with one or more of the individually controllable elements in the array of individually controllable elements, e.g., with 2 or more of the individually controllable elements in the array of individually controllable elements, such as 3 or more, 5 or more, 10 or more, 20 or more, 25 or more, 35 or more, or 50 or more. In one example, the MLA is movable (e.g., with the use of actuators) at least in the direction to and away from the substrate, e.g., with the use of one or more actuators. Being able to move the MLA to and away from the substrate allows, e.g., for focus adjustment without having to move the substrate.

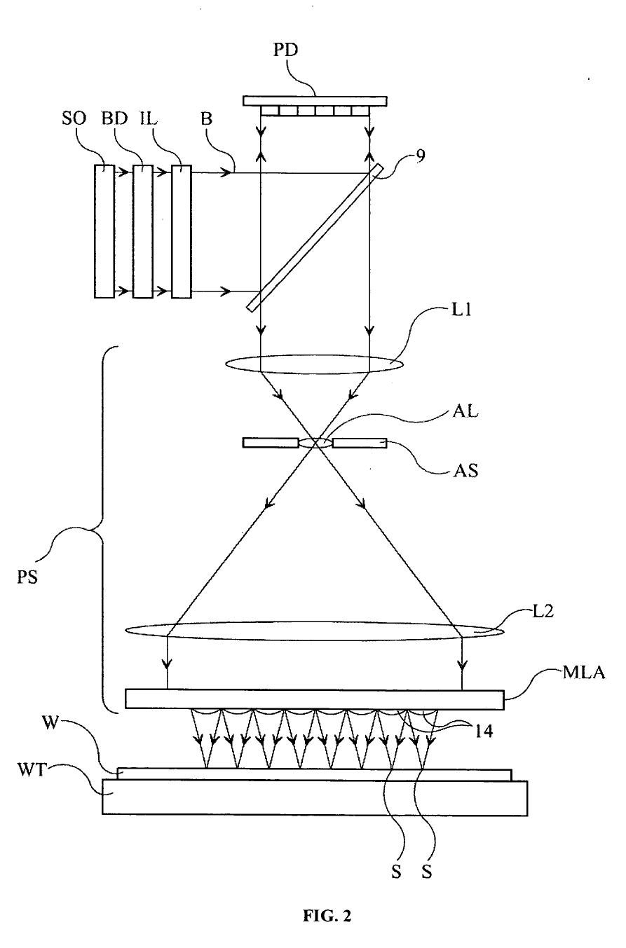

As herein depicted in FIGS. 1 and 2, the apparatus is of a reflective type (e.g., employing a reflective array of individually controllable elements). Alternatively, the apparatus can be of a transmissive type (e.g., employing a transmissive array of individually controllable elements).

The lithographic apparatus can be of a type having two (dual stage) or more substrate tables. In such “multiple stage” machines, the additional tables can be used in parallel, or preparatory steps can be carried out on one or more tables while one or more other tables are being used for exposure.

The lithographic apparatus can also be of a type wherein at least a portion of the substrate can be covered by an “immersion liquid” having a relatively high refractive index, e.g., water, so as to fill a space between the projection system and the substrate. An immersion liquid can also be applied to other spaces in the lithographic apparatus, for example, between the patterning device and the projection system. Immersion techniques are well known in the art for increasing the numerical aperture of projection systems. The term “immersion” as used herein does not mean that a structure, such as a substrate, must be submerged in liquid, but rather only means that liquid is located between the projection system and the substrate during exposure.

Referring again to FIG. 1, the illuminator IL receives a radiation beam from a radiation source SO. In one example, the radiation source provides radiation having a wavelength of at least 5 nm, e.g., at least 10 nm, at least 50 nm, at least 100 nm, at least 150 nm, at least 175 nm, at least 200 nm, at least 250 nm, at least 275 nm, at least 300 nm, at least 325 nm, at least 350 nm, or at least 360 nm. In one example, the radiation provided by radiation source SO has a wavelength of at most 450 nm, e.g., at most 425 nm, at most 375 nm, at most 360 nm, at most 325 nm, at most 275 nm, at most 250 nm, at most 225 nm, at most 200 nm, or at most 175 nm. In one example, the radiation has a wavelength including 436 nm, 405 nm, 365 nm, 355 nm, 248 nm, 193 nm, 157 nm, and/or 126 nm. In one example, the radiation includes a wavelength of around 365 nm or around 355 nm. In one example, the radiation includes a broad band of wavelengths, for example encompassing 365, 405, and 436 nm. A 355 nm laser source could be used. The source and the lithographic apparatus can be separate entities, for example when the source is an excimer laser. In such cases, the source is not considered to form part of the lithographic apparatus and the radiation beam is passed from the source SO to the illuminator IL with the aid of a beam delivery system BD comprising, for example, suitable directing mirrors and/or a beam expander. In other cases the source can be an integral part of the lithographic apparatus, for example when the source is a mercury lamp. The source SO and the illuminator IL, together with the beam delivery system BD if required, can be referred to as a radiation system.

The illuminator IL, can comprise an adjuster AD for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL can comprise various other components, such as an integrator IN and a condenser CO. The illuminator can be used to condition the radiation beam to have a desired uniformity and intensity distribution in its cross-section. The illuminator IL, or an additional component associated with it, can also be arranged to divide the radiation beam into a plurality of sub-beams that can, for example, each be associated with one or a plurality of the individually controllable elements of the array of individually controllable elements. A two-dimensional diffraction grating can, for example, be used to divide the radiation beam into sub-beams. In the present description, the terms “beam of radiation” and “radiation beam” encompass, but are not limited to, the situation in which the beam is comprised of a plurality of such sub-beams of radiation.

The radiation beam B is incident on the patterning device PD (e.g., an array of individually controllable elements) and is modulated by the patterning device. Having been reflected by the patterning device PD, the radiation beam B passes through the projection system PS, which focuses the beam onto a target portion C of the substrate W. With the aid of the positioner PW and position sensor IF2 (e.g., an interferometric device, linear encoder, capacitive sensor, or the like), the substrate table WT can be moved accurately, e.g., so as to position different target portions C in the path of the radiation beam B. Where used, the positioning means for the array of individually controllable elements can be used to correct accurately the position of the patterning device PD with respect to the path of the beam B, e.g., during a scan.

In one example, movement of the substrate table WT is realized with the aid of a long-stroke module (course positioning) and a short-stroke module (fine positioning), which are not explicitly depicted in FIG. 1. In one example, the apparatus is absent at least a short stroke module for moving substrate table WT. A similar system can also be used to position the array of individually controllable elements. It will be appreciated that the beam B can alternatively/additionally be moveable, while the object table and/or the array of individually controllable elements can have a fixed position to provide the required relative movement. Such an arrangement can assist in limiting the size of the apparatus. As a further alternative, which can, e.g., be applicable in the manufacture of flat panel displays, the position of the substrate table WT and the projection system PS can be fixed and the substrate W can be arranged to be moved relative to the substrate table WT. For example, the substrate table WT can be provided with a system for scanning the substrate W across it at a substantially constant velocity.

As shown in FIG. 1, the beam of radiation B can be directed to the patterning device PD by means of a beam splitter BS configured such that the radiation is initially reflected by the beam splitter and directed to the patterning device PD. It should be realized that the beam of radiation B can also be directed at the patterning device without the use of a beam splitter. In one example, the beam of radiation is directed at the patterning device at an angle between 0 and 90°, e.g., between 5 and 85°, between 15 and 75°, between 25 and 65°, or between 35 and 55° (the embodiment shown in FIG. 1 is at a 90° angle). The patterning device PD modulates the beam of radiation B and reflects it back to the beam splitter BS which transmits the modulated beam to the projection system PS. It will be appreciated, however, that alternative arrangements can be used to direct the beam of radiation B to the patterning device PD and subsequently to the projection system PS. In particular, an arrangement such as is shown in FIG. 1 may not be required if a transmissive patterning device is used.

The depicted apparatus can be used in several modes:

1. In step mode, the array of individually controllable elements and the substrate are kept essentially stationary, while an entire pattern imparted to the radiation beam is projected onto a target portion C at one go (i.e., a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the array of individually controllable elements and the substrate are scanned synchronously while a pattern imparted to the radiation beam is projected onto a target portion C (i.e., a single dynamic exposure). The velocity and direction of the substrate relative to the array of individually controllable elements can be determined by the (de-) magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

3. In pulse mode, the array of individually controllable elements is kept essentially stationary and the entire pattern is projected onto a target portion C of the substrate W using a pulsed radiation source. The substrate table WT is moved with an essentially constant speed such that the beam B is caused to scan a line across the substrate W. The pattern on the array of individually controllable elements is updated as required between pulses of the radiation system and the pulses are timed such that successive target portions C are exposed at the required locations on the substrate W. Consequently, the beam B can scan across the substrate W to expose the complete pattern for a strip of the substrate. The process is repeated until the complete substrate W has been exposed line by line.

4. In continuous scan mode, essentially the same as pulse mode except that the substrate W is scanned relative to the modulated beam of radiation B at a substantially constant speed and the pattern on the array of individually controllable elements is updated as the beam B scans across the substrate W and exposes it. A substantially constant radiation source or a pulsed radiation source, synchronized to the updating of the pattern on the array of individually controllable elements, can be used.

5. In pixel grid imaging mode, which can be performed using the lithographic apparatus of FIG. 2, the pattern formed on substrate W is realized by subsequent exposure of spots formed by a spot generator that are directed onto patterning device PD. The exposed spots have substantially the same shape. On substrate W the spots are printed in substantially a grid. In one example, the spot size is larger than a pitch of a printed pixel grid, but much smaller than the exposure spot grid. By varying intensity of the spots printed, a pattern is realized. In between the exposure flashes the intensity distribution over the spots is varied.

Combinations and/or variations on the above described modes of use or entirely different modes of use can also be employed.

In lithography, a pattern is exposed on a layer of resist on the substrate. The resist is then developed. Subsequently, additional processing steps are performed on the substrate. The effect of these subsequent processing steps on each portion of the substrate depends on the exposure of the resist. In particular, the processes are tuned such that portions of the substrate that receive a radiation dose above a given dose threshold respond differently to portions of the substrate that receive a radiation dose below the dose threshold. For example, in an etching process, areas of the substrate that receive a radiation dose above the threshold are protected from etching by a layer of developed resist. However, in the post-exposure development, the portions of the resist that receive a radiation dose below the threshold are removed and therefore those areas are not protected from etching. Accordingly, a desired pattern can be etched. In particular, the individually controllable elements in the patterning device are set such that the radiation that is transmitted to an area on the substrate within a pattern feature is at a sufficiently high intensity that the area receives a dose of radiation above the dose threshold during the exposure. The remaining areas on the substrate receive a radiation dose below the dose threshold by setting the corresponding individually controllable elements to provide a zero or significantly lower radiation intensity.

In practice, the radiation dose at the edges of a pattern feature does not abruptly change from a given maximum dose to zero dose even if the individually controllable elements are set to provide the maximum radiation intensity on one side of the feature boundary and the minimum radiation intensity on the other side. Instead, due to diffractive effects, the level of the radiation dose drops off across a transition zone. The position of the boundary of the pattern feature ultimately formed by the developed resist is determined by the position at which the received dose drops below the radiation dose threshold. The profile of the drop-off of radiation dose across the transition zone, and hence the precise position of the pattern feature boundary, can be controlled more precisely by setting the individually controllable elements that provide radiation to points on the substrate that are on or near the pattern feature boundary. These can be not only to maximum or minimum intensity levels, but also to intensity levels between the maximum and minimum intensity levels. This is commonly referred to as “grayscaling.”

Grayscaling provides greater control of the position of the pattern feature boundaries than is possible in a lithography system in which the radiation intensity provided to the substrate by a given individually controllable element can only be set to two values (namely just a maximum value and a minimum value). In an embodiment, at least three different radiation intensity values can be projected onto the substrate, e.g., at least 4 radiation intensity values, at least 8 radiation intensity values, at least 16 radiation intensity values, at least 32 radiation intensity values, at least 64 radiation intensity values, at least 128 radiation intensity values, or at least 256 radiation intensity values.

It should be appreciated that grayscaling can be used for additional or alternative purposes to that described above. For example, the processing of the substrate after the exposure can be tuned, such that there are more than two potential responses of regions of the substrate, dependent on received radiation dose level. For example, a portion of the substrate receiving a radiation dose below a first threshold responds in a first manner; a portion of the substrate receiving a radiation dose above the first threshold but below a second threshold responds in a second manner; and a portion of the substrate receiving a radiation dose above the second threshold responds in a third manner. Accordingly, grayscaling can be used to provide a radiation dose profile across the substrate having more than two desired dose levels. In an embodiment, the radiation dose profile has at least 2 desired dose levels, e.g., at least 3 desired radiation dose levels, at least 4 desired radiation dose levels, at least 6 desired radiation dose levels or at least 8 desired radiation dose levels.

It should further be appreciated that the radiation dose profile can be controlled by methods other than by merely controlling the intensity of the radiation received at each point on the substrate, as described above. For example, the radiation dose received by each point on the substrate can alternatively or additionally be controlled by controlling the duration of the exposure of the point. As a further example, each point on the substrate can potentially receive radiation in a plurality of successive exposures. The radiation dose received by each point can, therefore, be alternatively or additionally controlled by exposing the point using a selected subset of the plurality of successive exposures.

In order to form the required pattern on the substrate, it is necessary to set each of the individually controllable elements in the patterning device to the requisite state at each stage during the exposure process. Therefore, control signals, representing the requisite states, must be transmitted to each of the individually controllable elements. In one example, the lithographic apparatus includes a controller that generates the control signals. The pattern to be formed on the substrate can be provided to the lithographic apparatus in a vector-defined format, such as GDSII. In order to convert the design information into the control signals for each individually controllable element, the controller includes one or more data manipulation devices, each configured to perform a processing step on a data stream that represents the pattern. The data manipulation devices can collectively be referred to as the “datapath.”

The data manipulation devices of the datapath can be configured to perform one or more of the following functions: converting vector-based design information into bitmap pattern data; converting bitmap pattern data into a required radiation dose map (namely a required radiation dose profile across the substrate); converting a required radiation dose map into required radiation intensity values for each individually controllable element; and converting the required radiation intensity values for each individually controllable element into corresponding control signals.

FIG. 2 depicts an arrangement of the apparatus according to the present invention that can be used, e.g., in the manufacture of flat panel displays. Components corresponding to those shown in FIG. 1 are depicted with the same reference numerals. Also, the above descriptions of the various embodiments, e.g., the various configurations of the substrate, the contrast device, the MLA, the beam of radiation, etc., remain applicable.

FIG. 2 depicts an arrangement of a lithographic apparatus, according to one embodiment of the present invention. This embodiment can be used, e.g., in the manufacture of flat panel displays. Components corresponding to those shown in FIG. 1 are depicted with the same reference numerals. Also, the above descriptions of the various embodiments, e.g., the various configurations of the substrate, the contrast device, the MLA, the beam of radiation, etc., remain applicable.

As shown in FIG. 2, the projection system PS includes a beam expander, which comprises two lenses L1, L2. The first lens L1 is arranged to receive the modulated radiation beam B and focus it through an aperture in an aperture stop AS. A further lens AL can be located in the aperture. The radiation beam B then diverges and is focused by the second lens L2 (e.g., a field lens).

The projection system PS further comprises an array of lenses MLA arranged to receive the expanded modulated radiation B. Different portions of the modulated radiation beam B, corresponding to one or more of the individually controllable elements in the patterning device PD, pass through respective different lenses in the array of lenses MLA. Each lens focuses the respective portion of the modulated radiation beam B to a point which lies on the substrate W. In this way an array of radiation spots S is exposed onto the substrate W. It will be appreciated that, although only eight lenses of the illustrated array of lenses 14 are shown, the array of lenses can comprise many thousands of lenses (the same is true of the array of individually controllable elements used as the patterning device PD).

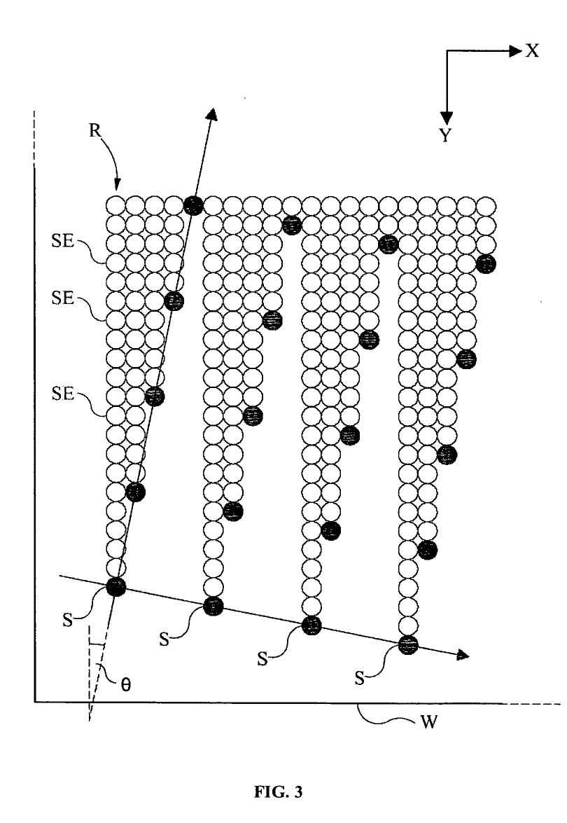

FIG. 3 illustrates schematically how a pattern on a substrate W is generated using the system of FIG. 2, according to one embodiment of the present invention. The filled in circles represent the array of spots S projected onto the substrate W by the array of lenses MLA in the projection system PS. The substrate W is moved relative to the projection system PS in the Y direction as a series of exposures are exposed on the substrate W. The open circles represent spot exposures SE that have previously been exposed on the substrate W. As shown, each spot projected onto the substrate by the array of lenses within the projection system PS exposes a row R of spot exposures on the substrate W. The complete pattern for the substrate is generated by the sum of all the rows R of spot exposures SE exposed by each of the spots S. Such an arrangement is commonly referred to as “pixel grid imaging,” discussed above.

It can be seen that the array of radiation spots S is arranged at an angle θ relative to the substrate W (the edges of the substrate lie parallel to the X and Y directions). This is done so that when the substrate is moved in the scanning direction (the Y-direction), each radiation spot will pass over a different area of the substrate, thereby allowing the entire substrate to be covered by the array of radiation spots 15. In one example, the angle θ is at most 20°, 10°, e.g., at most 5°, at most 3°, at most 1°, at most 0.5°, at most 0.25°, at most 0.10°, at most 0.05°, or at most 0.01°. In one example, the angle θ is at least 0.001°.

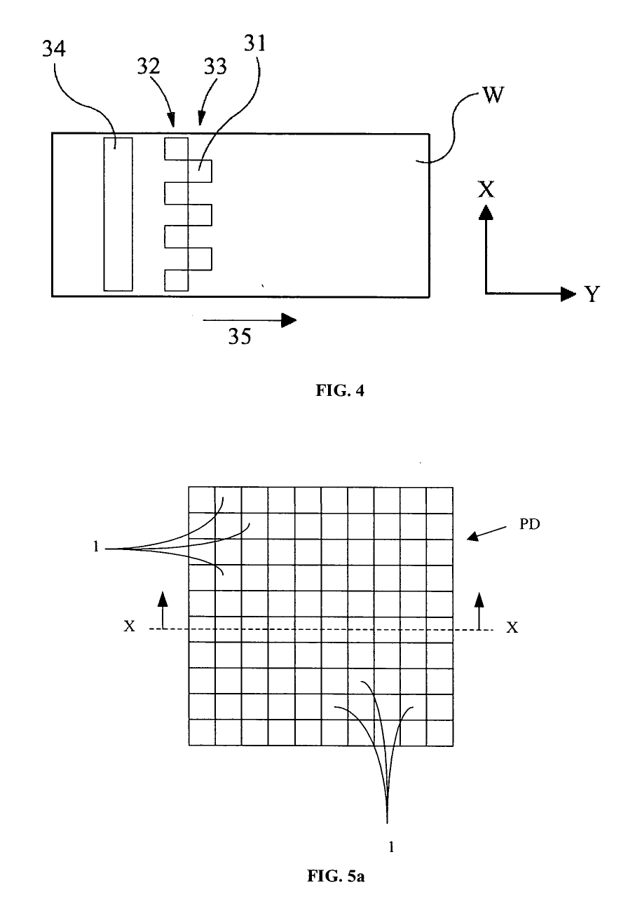

FIG. 4 shows schematically how an entire substrate W can be exposed in a single scan, by using a plurality of optical engines. Eight optical engines 31 are arranged to produce arrays of radiation spots (not shown). The optical engines 31 are arranged in two rows 32, 33 in a ‘chess board’ configuration such that the edge of one array of radiation spots slightly overlaps (in the x-direction) with the edge of the adjacent array of radiation spots. In one embodiment, a row of lasers and associated detectors 34 is provided beneath the substrate. The row of lasers and associated detectors 34 will be described in detail further below. In an embodiment, the optical engines are arranged in at least 3 rows, for instance 4 rows or 5 rows. In this way, a band of radiation extends across the width of the substrate W, allowing exposure of the entire substrate to be performed in a single scan. It will be appreciated that any suitable number of optical engines can be used. In an embodiment, the number of optical engines is at least 1, for instance at least 2, at least 4, at least 8, at least 10, at least 12, at least 14, or at least 17. In an embodiment, the number of optical engines is less than 40, e.g. less than 30 or less than 20.

Each optical engine can comprise a separate illumination system IL, patterning device PD and projection system PS as described above. It is to be appreciated, however, that two or more optical engines can share at least a part of one or more of the illumination system, patterning device and projection system.

In one example, the patterning device PD can be a mirror array PD. The mirror array PD is an array of individually controllable mechanical elements (i.e., each element being a mirror) that is used to impart a pattern to a cross-section of the radiation beam B. Individual elements of the array are often referred to as micro-electromechanical devices (or MEMs), whereas the array as a whole can be referred to as a micro-electromechanical system (or MEMS). A lithographic apparatus that utilizes a maskless approach to lithography often employs micro-electromechanical devices (which can be mirrors) to impart the pattern to the radiation beam B. One of the problems with the use of micro-electromechanical devices is that, while they are manufactured precisely enough for some applications (e.g., for use in commercial digital projection systems), they are often not manufactured precisely enough for use in extremely high precision applications, such as optical lithography. This is particularly true where the micro-electromechanical device has to be controlled extremely accurately, such that it has a range of operating positions, thereby acting as a contrast device.

Due to the imprecise nature of the manufacture of micro-electromechanical devices (e.g., mirror arrays PD), one or more elements of a micro-electromechanical array can perform differently under identical operating conditions. For example, a signal (e.g., voltage) can be applied to a mirror array PD, such that all elements within the array PD are to be tilted to a specific angle. However, due to the imprecise nature of the manufacture of the mirror array PD, some of the elements within the mirror array PD can tilt to different angles, even though the voltage applied to each element of the array PD is the same.

In one embodiment of the present invention, there is provided a correction system CS for detecting non-uniformities in elements of an array of a patterning device, and a system for correcting the non-uniformities. In providing such a correction system CS this embodiment of the present invention improves the uniformity and consistency between elements of the array.

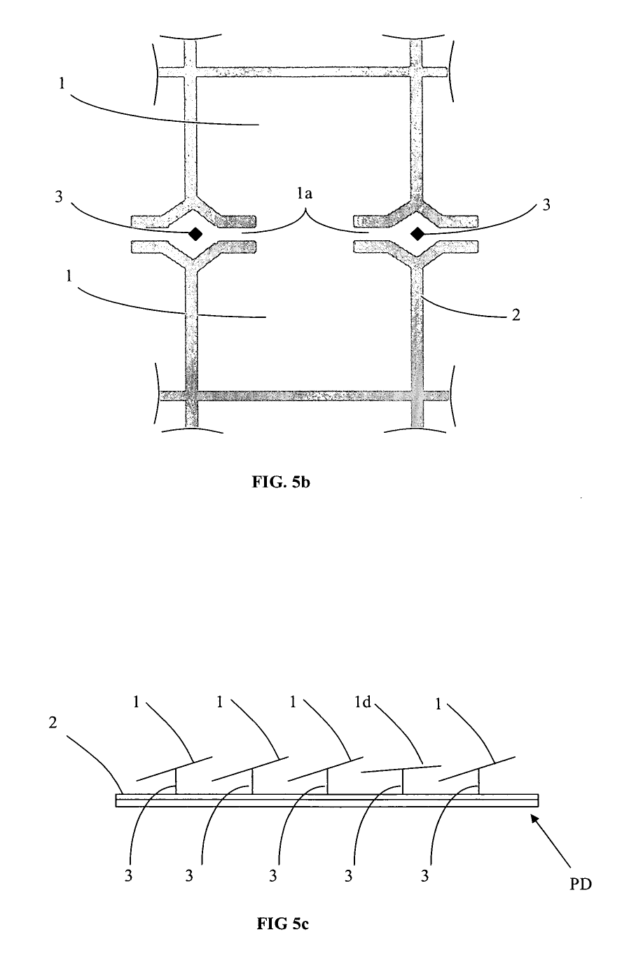

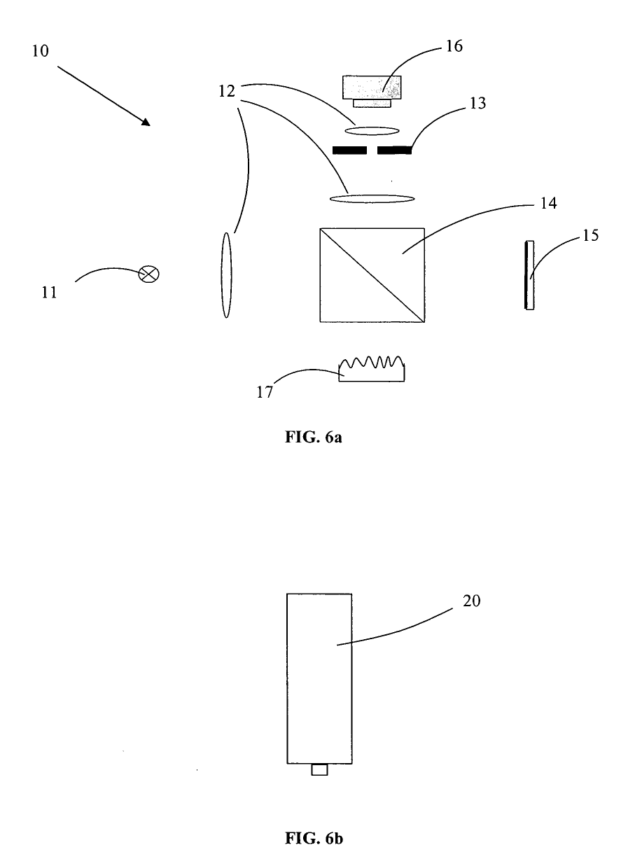

FIG. 5a is a simplified view of a mirror array PD, according to one embodiment of the present invention. The mirror array PD is provided with an array of individually controllable mirrors 1. A more detailed view of a mirror 1 of the array PD according to one embodiment of the present invention is shown in FIG. 5b. The mirror 1 is a sheet of highly reflective material. The mirror 1 is able to tilt relative to a base layer 2. The mirror is attached to the base layer 2 by way of posts 3, and tilts about the posts 3. Material 1a extending from the posts 3 to the main body of the mirror 1 allows the mirror to tilt. The pieces of material 1a act as flexible connectors 1a. In order for this to happen, the flexible connectors 1a twist. The flexible connectors 1a are resilient, such that they return to their original shape after being deformed (with the effect that the mirror 1 is returned to an equilibrium position when no voltage is applied thereto).

By inducing an appropriate electrostatic or capacitive force between parts of the mirror 1 and base layer 2, one part of the mirror 1 is forced away from the base layer 2, while another (opposite) part is attracted toward the base layer. Thus, the mirror 1 can be tilted to a desired angle relative to the base layer 2. By varying the angle at which mirrors 1 of the mirror array PD extend from the base layer 2, a contrast pattern can be applied to a radiation beam B that is incident upon the mirror array PD. As the angles at which the mirrors 1 extend from the base layer 2 can be varied, the mirrors act as contrast devices, whereby grey-scaling can be applied to the patterning of the radiation beam B and subsequent patterning of the substrate W.

In one example, the mirror array PD shown in FIG. 5a is typically made by a lithographic processes. Due to non-uniformity in the lithographic processes used to make the mirror array PD, individual mirrors 1 of the array may not be identical to one another.

FIG. 5c shows a cross-section view of part of the mirror array PD of FIG. 5a taken along the line X-X, according to one embodiment of the present invention. All mirrors 1 in the mirror array PD have been subjected to an identical force (i.e., the same voltage has been applied to each mirror 1), pushing part of the mirror 1 away from the base layer and attracting an opposite part toward the base layer 2. Thus, in theory, all of the mirrors 1 should tilt at an equal angle relative to a plane parallel to the base layer 2. However, due to non-uniformities in the lithographic processes, one of the mirrors 1d (hereinafter referred to as ‘the non-uniform mirror 1d’) does not tilt to the same degree as adjacent mirrors 1.

The non-uniform mirror Id may not tilt to the same degree as the rest of the mirrors 1 for a number of reasons. Referring to FIG. 5b, the flexible connectors 1a twist when the mirror is made to tilt, and if the flexible connectors 1a are too long or wide, the angle that the non-uniform mirror 1d tilts for a given applied voltage can be affected. Any non-uniformity in the physical structure of the mirrors 1, or the structures to which they are attached, can result in non-uniform mirrors 1d tilting at an unacceptable angle when a specific force is applied thereto.

If the angle at which the non-uniform mirror 1d tilts is not as intended, there is a chance that the pattern applied to the substrate W will also not be uniform. For example, a region of the substrate can be underexposed or overexposed. It is therefore desirable to be able to detect non-uniformities in the mirrors 1, and correct these non-uniformities such that for a given applied voltage, all the mirrors tilt at the same angle.

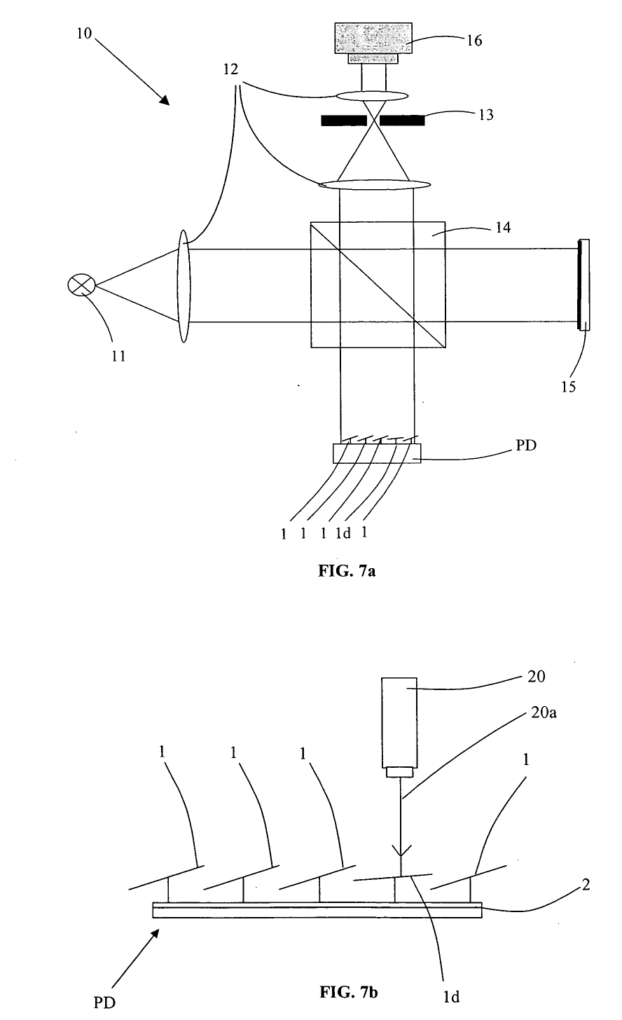

FIGS. 6a and 6b illustrate the correction system labeled CS in FIG. 1 in more detail, according to one embodiment of the present invention. The correction system is arranged to measure non-uniformities in the mirrors 1 of the array PD, and correct these non-uniformities. The correction system comprises an interferometer 10, as shown in FIG. 6a, and a laser 20, as shown in FIG. 6b.

In one example, the interferometer of FIG. 6a is a white light interferometer 10. The interferometer 10 comprises a white (e.g., broad band) source 11, an array of appropriately located lenses 12, an iris diaphragm 13, and a beam splitter 14. The interferometer 10 also comprises a mirror 15 and a charge coupled device (CCD) detector 16. A white light interferometer 10 is generally identical in structure to a ‘standard’ interferometer, but one mirror of a ‘standard’ interferometer is replaced by a surface to be analyzed 17 (e.g., a surface, the topography of which is to be measured). In the case of the present invention, the surface to be analyzed is the surface of the mirror array PD. White light interferometers 10 use a light source with a broad optical bandwidth to determine the profile (or topography) of a surface. As white light interferometers are known to a skilled artisan, the exact details of their operation will not be discussed in detail here.

FIG. 6b illustrates a laser 20. The laser 20 is a femtosecond laser. A femtosecond laser has an extremely short pulse duration (of the order of 1×10-15 seconds). Femtosecond lasers typically operate in the infrared region of the electromagnetic spectrum (e.g., 1053 nm). Due to the power of femtosecond lasers and their extremely short pulse duration, they are extremely useful for the accurate cutting and ablation of materials. Each pulse has a very large peak power, but a low overall pulse energy, meaning that a femtosecond laser can be used to make very small (submicron) cuts and/or ablations without damaging surrounding material. The cutting and/or ablation of material is achieved by laser induced photo disruption via optical breakdown of the material being cut/ablated. Femtosecond lasers are well known, and a detailed explanation of their operation will therefore not be given here.

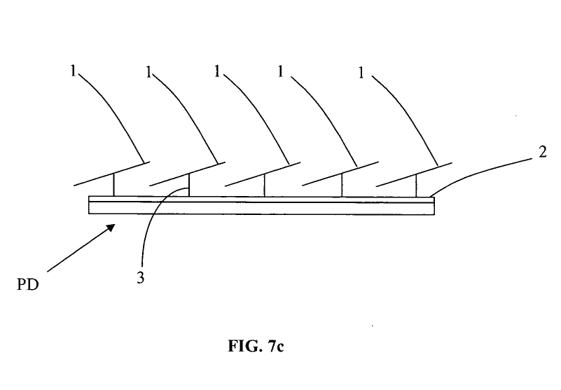

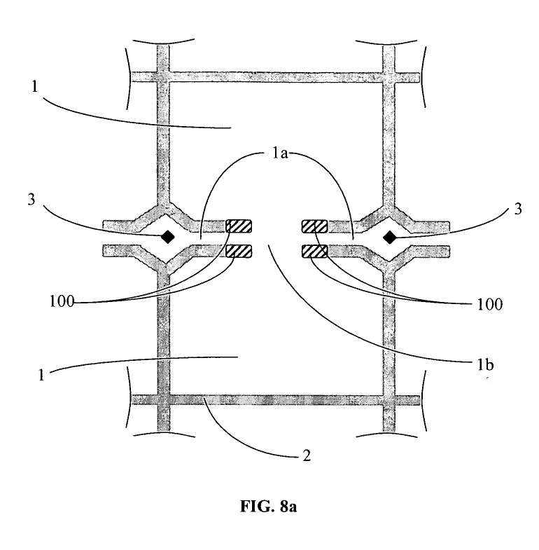

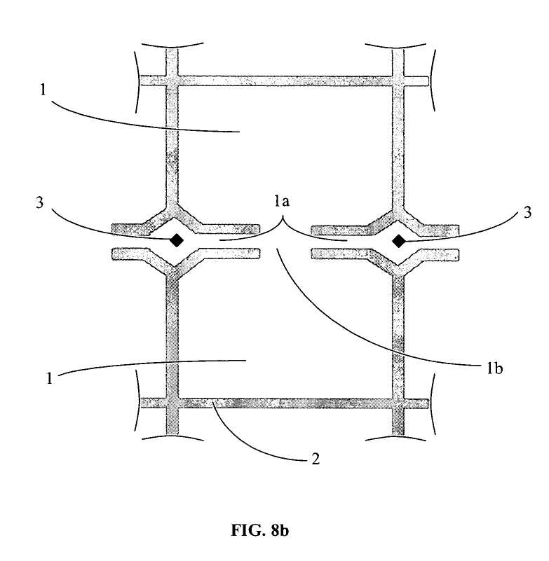

FIGS. 7a to 7c illustrate operation of the correction system, according to one embodiment of the present invention. Firstly, the white light interferometer 10 is used to measure the topography of the mirror array PD as shown in FIG. 7a. The white light interferometer 10 can substantially simultaneously measure the topography of a large number of mirrors, for example a region comprising 100×100 mirrors. The topography of the mirror array PD is measured while identical voltages are applied to each mirror 1 in the array. In this way, any non-uniformities in the mirrors 1 will be highlighted in the measurement of the topography, i.e., a mirror that does not subtend at the same angle as the rest of the mirrors will be identified in the surface topography. An individual mirror 1 can also be measured to determine further details of its topography (i.e., a higher resolution measurement can be undertaken). Measurement of the topography of the mirror array PD can reveal a non-uniform mirror 1d requiring correction.

FIG. 7b shows the laser 20 emitting a pulse of radiation at a specific location on the non-uniform mirror 1d. The location and amount of radiation will vary depending on the nature of the non-uniformity and its severity. For example, if it is clear from the topography measurement that the non-uniform mirror 1d is tilting at an angle that is lower than the rest (or the majority) of the mirrors 1 in the array, it can be clear from modeling of the mirrors 1 (or empirical experimentation, trial and error etc.) that the flexible connectors 1a are too long and require cutting or thinning. In this case, the surface of the flexible connectors 1a can be ablated (or even cut through), such that when a voltage is applied to the non-uniform mirror 1d, it tilts at an angle equal to that of all other mirrors in the array PD.

FIG. 7c shows the cross-section of FIG. 5c, but with a corrective measure applied to the non-uniform mirror 1d shown therein. It can be seen that all of the mirrors 1 tilt at the same angle with respect to a plane parallel to the base layer 2.

It will be appreciated that the location and magnitude of the radiation to be applied to the mirror 1 can be determined from the measurement of the topography. It will be appreciated that in some circumstances, however, that the corrective measure required can be inferred from knowledge of the mirrors 1 of the array PD, empirical results derived from various attempts at correcting non-uniformities or from modeling of the mirrors 1 of the array PD.

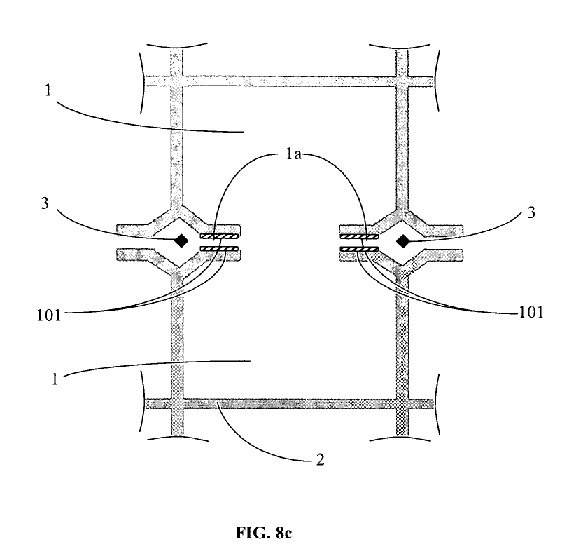

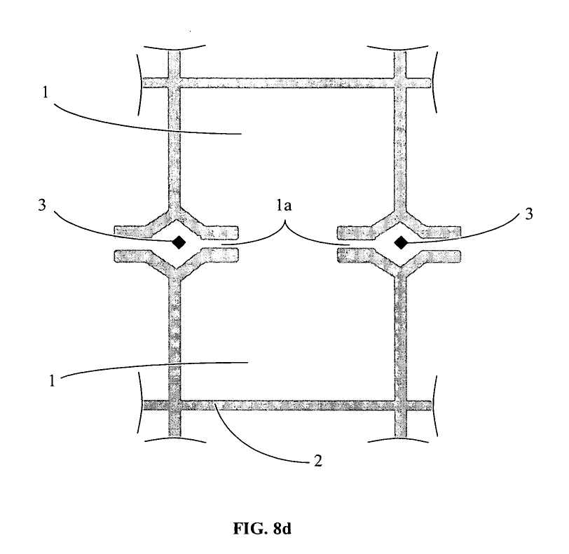

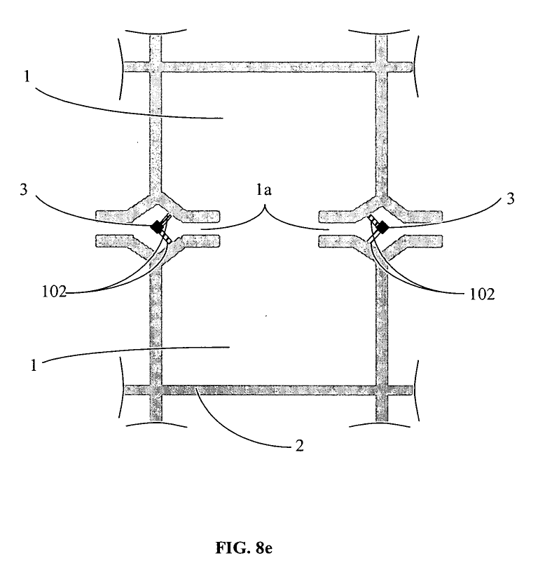

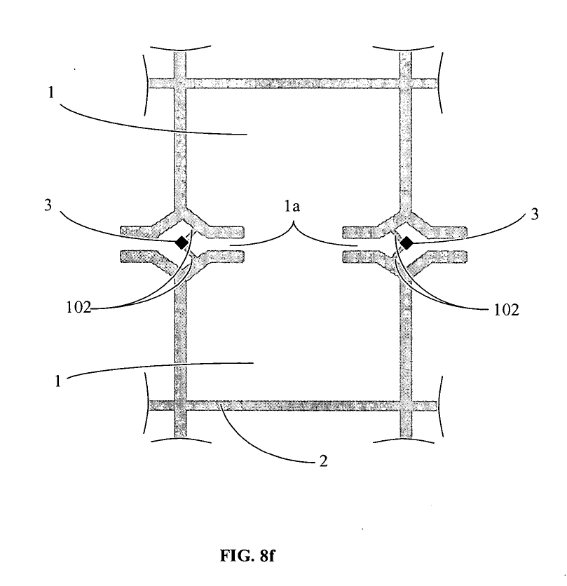

FIGS. 8a to 8f illustrate corrective measures that can be applied to a non-uniform mirror 1d of the array PD, according to various embodiments of the present invention.

FIG. 8a shows that a part of the mirror 1b extending between posts 3 that has been ablated 100 in order to increase the length of the flexible connectors 1a.

FIG. 8b shows the mirror of FIG. 8a after correction. It can be seen that the flexible connectors 1a have been lengthened. As the flexible connectors 1a twist when a voltage is applied to the mirror, the mirror can now tilt at a greater angle for an applied voltage than it would have prior to correction as the amount of material forming the flexible connectors 1a has changed.

FIG. 8c shows that a part of the flexible connectors 1a has been ablated 101 in order to reduce the widths of the flexible connectors 1a.

FIG. 8d shows the mirror of FIG. 8c after correction. It can be seen that the flexible connectors 1a have been reduced in width. As the flexible connectors 1a twist when a voltage is applied to the mirror, the mirror can now tilt at a greater angle for an applied voltage than it would have prior to correction as the amount of material forming the flexible connectors 1a has changed.

FIG. 8e shows that a part of the material 102 attaching the mirror 1 to the posts 3 has been ablated in order to make a small incision therein.

FIG. 8f shows the mirror of FIG. 8e after correction. It can be seen that a part of the material 102 attached to the posts 3 has been cut away. Such a small cut in the material 102 attaching the mirror to the posts 3 can cause a small change in the degree to which the mirror tilts for a given applied voltage.

Referring to FIG. 8 and FIG. 7b, it will be appreciated that the areas and severity of ablation (or cutting) will vary depending on the changes required to the movement properties of the mirror 1. For example, severe changes (or first order changes) can be induced by changing the shape of the flexible connectors 1a. Less severe changes (second order changes) can be induced by ablating areas of the posts 3. It will be appreciated that it is desirable not to ablate the surface of the mirror 1 as reflective properties of the mirror can be degraded. It can be desirable to ablate material from the areas to be corrected, as opposed to cutting through the area. For example, cutting the areas to be corrected can cause the radiation beam 20a emitted by the laser 20 to pass through to the base layer 2. If the radiation 20a from the laser 20 does pass through to the base layer 2, the base layer 2 can be damaged which can have undesirable effects on the operation of the mirror array PD. Furthermore, by ablating material from the surface of the mirror 1, it is evaporated away from the surface of the mirror array PD, such that ablated material is not deposited under the mirror 1 (i.e., in between the mirror and the base layer 2).

It will be appreciated that the above-mentioned embodiments have been described by way of example only, and that various modifications can be made thereto.

It will be appreciated that the white light interferometer has been described by way of example only. For example, the white light interferometer can be replaced with any suitable device that is capable of measuring the topography of the surface of the patterning device PD.

Similarly, the laser 20 can be replaced with another suitable laser, or any suitable device that can apply a corrective measure to the elements of the patterning device PD.

It can take more than one iteration of topography measurement and application of a corrective measure to fully correct the non-uniformity of an element of the array PD. It can take more than one ‘shot’ of the laser to apply a corrective measure to an element of an array of elements.

A corrective measure may not be applied symmetrically to the mirror. For example, one flexible connector la can be ablated, while another (e.g., a flexible connector la on an opposite side of the mirror) is not. Such non-symmetrical application of a corrective measures can be used to correct, for example, twisting of the mirror, where one side of the mirror tilts to a greater degree than another side.

It will be appreciated that the application of the present invention to a mirror array PD is given by way of example only. The invention is equally applicable to any patterning device having an array of individual mechanical elements whose properties (either in operation or in a non-operating state) affect the way a desired pattern is applied to a radiation beam which is used to pattern a substrate. For example, the present invention is equally applicable to the analysis and correction of elements of an actuable diffraction grating.

The white light interferometer 10 and laser 20 have been described as separate pieces of apparatus. However, the laser 10 and white light interferometer 20 can be combined to form a single piece of apparatus, such that measurement of the topography and application of a corrective measure can be applied without having to reposition the laser 20, interferometer 10 or mirror array PD.

It will be understood that an individual mechanical element can comprise a mirror. Structures attaching the mirror to, for example, a base layer can also be considered as part of the mirror, even though those structures may not be used in applying a contrast to a (part of a) radiation beam.

The correction system can be moved relative to the patterning device, or the patterning device can be moved relative to the correction system. The measurement and correction can be undertaken in the lithographic apparatus, or adjacent to the lithographic apparatus. If the correction is applied in the lithographic apparatus, it will be appreciated that it will be preferable to provide a method and apparatus of extracting any ablated material. Otherwise, the ablated material can contaminate sensitive surfaces of apparatus within the lithographic apparatus. The radiation beam 20a can be directed at the area to be corrected by the radiation source 20. Alternatively, the radiation beam can be steered toward the area to be corrected by a steering system. For example, the radiation beam 20a can be emitted by the radiation source 20, and then steered toward the area to be corrected by a mirror, or system of mirrors and lenses.

It will be appreciated that the correction system can be used independently, i.e., not in conjunction with a lithographic apparatus. For example, the correction system can be used to correct elements of any suitable patterning device.

The above description refers to light, light sources and beams of light. It will be appreciated that the light referred to is not limited to light having a particular wavelength, and can include other wavelengths including ultraviolet light or infrared light which are suitable for lithography, as discussed above.

Although specific reference can be made in this text to the use of lithographic apparatus in the manufacture of a specific device (e.g., an integrated circuit or a flat panel display), it should be understood that the lithographic apparatus described herein can have other applications. Applications include, but are not limited to, the manufacture of integrated circuits, integrated optical systems, guidance and detection patterns for magnetic domain memories, flat-panel displays, liquid-crystal displays (LCDs), thin-film magnetic heads, micro-electromechanical devices (MEMS), etc. Also, for instance in a flat panel display, the present apparatus can be used to assist in the creation of a variety of layers, e.g., a thin film transistor layer and/or a color filter layer.

Although specific reference can have been made above to the use of embodiments of the invention in the context of optical lithography, it will be appreciated that the invention can be used in other applications, for example imprint lithography, where the context allows, and is not limited to optical lithography. In imprint lithography a topography in a patterning device defines the pattern created on a substrate. The topography of the patterning device can be pressed into a layer of resist supplied to the substrate whereupon the resist is cured by applying electromagnetic radiation, heat, pressure or a combination thereof. The patterning device is moved out of the resist leaving a pattern in it after the resist is cured.

While specific embodiments of the invention have been described above, it will be appreciated that the invention can be practiced otherwise than as described. For example, the invention can take the form of a computer program containing one or more sequences of machine-readable instructions describing a method as disclosed above, or a data storage medium (e.g. semiconductor memory, magnetic or optical disk) having such a computer program stored therein.

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

It is to be appreciated that the Detailed Description section, and not the Summary and Abstract sections, is intended to be used to interpret the claims. The Summary and Abstract sections can set forth one or more, but not all exemplary embodiments of the present invention as contemplated by the inventor(s), and thus, are not intended to limit the present invention and the appended claims in any way.

What is claimed is:

1. An apparatus, comprising:
a topography measurement device that measures a topography of at least one mechanical element of a patterning device, the patterning device comprising an array of individually controllable mechanical elements that are arranged to pattern a radiation beam; and
a corrective device that corrects a mechanical property of the at least one mechanical element based on the measuring of the topography measurement device.

2. The apparatus of claim 1, wherein the corrective device is arranged to ablate material from a surface of the mechanical element.

3. The apparatus of claim 1, wherein the corrective device comprises a laser.

4. The apparatus of claim 1, wherein the corrective device comprises a femtosecond laser.

5. The apparatus of claim 1, wherein the topography measurement device comprises an interferometer.

6. The apparatus of claim 1, wherein the topography measurement device comprises a white light interferometer.

7. The apparatus of claim 1, wherein the at least one mechanical element comprises a mirror.

8. The apparatus of claim 1, wherein the array of individually controllable mechanical elements comprises a mirror array.

9. The apparatus of claim 8, wherein the mirror array is programmable.

10. The apparatus of claim 1, wherein the radiation beam comprises extreme ultra violate (EUV) or deep ultra violate (DUV) radiation.

11. A corrective system arranged to apply a corrective measure to at least one mechanical element of a patterning device, the patterning device comprising an array of individually controllable mechanical elements that are arranged to impart a pattern to a radiation beam, the system comprising:
a topography measurement device that measures a topography of the at least one mechanical element of the array; and
a corrective device that corrects a mechanical property of the at least one mechanical element based on the measuring of the topography measurement device.

12. A method of correcting at least one mechanical element of a patterning device, the method comprising:
(a) measuring a topography of the at least one mechanical element; and
(b) correcting a mechanical property of the at least one mechanical element on based on step (a).

13. The method of claim 12, wherein step (b) comprises ablating material from a surface of the at least one mechanical element.

14. The method of claim 12, wherein step (b) comprises making a cut in the at least one mechanical element.

15. The method of claim 12, further comprising:
using at least one flexible connector as the at least one mechanical element; and
step (b) comprises shortening the flexible connector.

16. The method of claim 15, wherein the shortening step comprises shortening the flexible connector by ablation or cutting.

17. The method of claim 12, further comprising:
using at least one flexible connector as the at least one mechanical element; and
step (b) comprises reducing a width of the flexible connector.

18. The method of claim 17, wherein the reducing step comprises reducing the flexible connector by ablation or cutting.

19. The method of claim 12, further comprising:
coupling the at least one mechanical element to a base layer by way of at least one post; and
wherein step (b) comprises cutting or ablating material in proximate the post.
